(19) United States
(12) Patent Application Publication
(10) Pub. No.: US 2026/0094404 A1
(43) Pub. Date: Apr. 2, 2026

(54) SEGMENTATION OF OBJECTS IN AN IMAGE

(71) Applicant: Google LLC, Mountain View, CA (US)

(72) Inventor: Bryan FELDMAN, Mountain View, CA (US)

(73) Assignee: Google LLC, Mountain View, CA (US)

(21) Appl. No.: 19/113,362

(22) PCT Filed: May 9, 2024
(86) PCT No.: PCT/US2024/028647

§ 371 Date: Mar. 19, 2025

Related U.S. Application Data
(60) Provisional application No. 63/465,224, filed on May 9, 2023.
(60) Provisional application No. 63/465,226, filed on May 9, 2023.
(60) Provisional application No. 63/465,230, filed on May 9, 2023.
(60) Provisional application No. 63/465,232, filed on May 9, 2023.
(60) Provisional application No. 63/562,634, filed on Mar. 7, 2024.

(51) Int. Cl. G06V 10/26; G06F 3/0482; G06F 3/04845; G06T 5/77; G06V 10/82; G06V 20/50; G06V 40/16

(52) U.S. Cl. CPC G06V 10/26; G06F 3/0482; G06F 3/04845; G06T 5/77; G06V 10/82; G06V 20/50; G06V 40/161; G06T 2200/24; G06T 2207/20084; G06T 2207/30201

(57) ABSTRACT

A media application performs object recognition on an initial image to identify a set of objects in the initial image. The media application determines whether the initial image is an outdoor scene. Responsive to the initial image being an outdoor scene, the media application determining a sky segment from the initial image. The media application determines whether the initial image includes a subject that is human or animal. Responsive to the initial image including the subject, the media application determines a subject segment from the initial image. The media application receives at a user interface that includes the initial image, user input corresponding to selection of a selected object from the set of objects. The media application updates the user interface to include an indication that the selected object was selected.

### CROSS-REFERENCE TO RELATED APPLICATIONS

The present application claims priority to U.S. Provisional Patent Application No. 63/465,232, filed May 9, 2023, and titled “Selecting a Region of an Image”; U.S. Provisional Patent Application No. 63/465,224, filed May 9, 2023, and titled “Relighting of Outdoor Images Using Machine Learning”; U.S. Provisional Patent Application No. 63/465,226, filed May 9, 2023, and titled “Prompt-Drive Image Editing Using Machine-Learning”; U.S. Provisional Patent Application No. 63/465,230, filed May 9, 2023, and titled “Repositioning Objects in an Image”; and U.S. Provisional Patent Application No. 63/562,634, filed Mar. 7, 2024 and titled “Performing Scene Impact Editing Tasks Using Diffusion Neural Networks,” each of which is incorporated herein in its entirety.

### BACKGROUND

As techniques for editing images improve, it becomes increasingly important to intuitively translate user intent to object selection in a user interface.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes performing object recognition on an initial image to identify a set of objects in the initial image. The method further includes determining whether the initial image is an outdoor scene. Responsive to the initial image being an outdoor scene, the method determines a sky segment from the initial image. The method further includes determining whether the initial image includes a subject that is human or animal. Responsive to the initial image including the subject, the method determines a subject segment from the initial image. The method determines whether the initial image includes one or more distracting objects. Responsive to the initial image including one or more distracting objects, the method determines one or more distracting segments from the initial image. The method further includes, at a user interface that includes the initial image, user input corresponding to selection of a selected object from the set of objects. The method further includes updating the user interface to include an indication that the selected object was selected.

In some embodiments, the user input includes multiple taps of the selected object and further includes determining a number of taps from the user input and determining the selected object based on the number of taps, wherein a first tap is associated with a different region than a second tap. In some embodiments, the method further includes responsive to the initial image including the subject, generating a background segment, wherein the subject segment is associated with a foreground region, the background segment is associated with a background region, and pixels in the initial image are associated with the foreground region or the background region and determining that the user input corresponds to the foreground region based on the user input making contact with pixels that are associated with the foreground region. In some embodiments, performing object recognition to identify objects in the initial image includes determining object bounding boxes for each of the objects and the method further includes determining that the user input corresponds to the selected object based on a proximity of the user input to a closest object bounding box.

In some embodiments, a convolutional neural network (CNN) performs segmentation and the method further includes providing the initial image and a heatmap of keypoints as input to the CNN and outputting, with the convolutional neural network, segmentation masks that correspond to the sky segment, the subject segment, and the one or more distracting segments. In some embodiments, the user input includes selection of a sky and the method further includes receiving a request from a user to change a lighting in the initial image; providing, as input to a diffusion model, an initial image and a request to change a lighting in the initial image; and outputting, with the diffusion model, an output image that satisfies the request. In some embodiments, the user input includes selection of one or more background objects for removal and the method further includes removing the one or more distracting objects from the initial image based on object recognition and generating a modified image that includes inpainting of pixels associated with the one or more distracting segments.

In some embodiments, the selected object is an incomplete object and an omitted portion of the incomplete object is cut off by a boundary of the initial image or obscured by another object, the method including generating a segmentation mask that includes the incomplete object; removing the incomplete object from the initial image; generating an inpainted image that replaces incomplete object pixels corresponding to the incomplete object with background pixels that match a background in the initial image; providing, as input to a diffusion model, the segmentation mask, the incomplete object, and the inpainted image; outputting, with the diffusion model, a complete object; and generating a modified image by blending one or more versions of the complete object with one or more versions of the inpainted image using the preserving mask. In some embodiments, the method further includes receiving a textual request to change the selected object in the initial image; determining, from the initial image, a face segment for a face of the subject based on the subject segment; generating a preserving mask that corresponds to the face segment; providing the textual request, the initial image, and the preserving mask as input to a diffusion model; and outputting, with the diffusion model, an output image that satisfies the textual request.

A non-transitory computer-readable medium with instructions stored thereon that, when executed by one or more processors, cause the one or more processors to perform operations. The operations include performing object recognition on an initial image to identify a set of objects in the initial image; determining whether the initial image is an outdoor scene; responsive to the initial image being an outdoor scene, determining a sky segment from the initial image; determining whether the initial image includes a subject that is human or animal; responsive to the initial image including the subject, determining a subject segment from the initial image; determining whether the initial image includes one or more distracting objects; responsive to the initial image including one or more distracting objects, determining one or more distracting segments from the initial image; receiving, at a user interface that includes the initial image, user input corresponding to selection of a selected object from the set of objects; and updating the user interface to include an indication that the selected object was selected.

In some embodiments, the user input includes multiple taps of the selected object and the operations further include determining a number of taps from the user input and determining the selected object based on the number of taps, wherein a first tap is associated with a different region than a second tap. In some embodiments, the operations further include responsive to the initial image including the subject, generating a background segment, wherein the subject segment is associated with a foreground region, the background segment is associated with a background region, and pixels in the initial image are associated with the foreground region or the background region and determining that the user input corresponds to the foreground region based on the user input making contact with pixels that are associated with the foreground region. In some embodiments, performing object recognition to identify objects in the initial image includes determining object bounding boxes for each of the objects and the operations further include determining that the user input corresponds to the selected object based on a proximity of the user input to a closest object bounding box. In some embodiments, wherein a CNN performs segmentation and the operations further include providing the initial image and a heatmap of keypoints as input to the CNN and outputting, with the convolutional neural network, segmentation masks that correspond to the sky segment, the subject segment, and the one or more distracting segments. In some embodiments, the user input includes selection of a sky and the operations further include receiving a request from a user to change a lighting in the initial image; providing, as input to a diffusion model, an initial image and a request to change a lighting in the initial image; and outputting, with the diffusion model, an output image that satisfies the request.

A system comprising a processor and a memory coupled to the processor, with instructions stored thereon that, when executed by the processor, cause the processor to perform operations. The operations include performing object recognition on an initial image to identify a set of objects in the initial image; determining whether the initial image is an outdoor scene; responsive to the initial image being an outdoor scene, determining a sky segment from the initial image; determining whether the initial image includes a subject that is human or animal; responsive to the initial image including the subject, determining a subject segment from the initial image; determining whether the initial image includes one or more distracting objects; responsive to the initial image including one or more distracting objects, determining one or more distracting segments from the initial image: receiving, at a user interface that includes the initial image, user input corresponding to selection of a selected object from the set of objects; and updating the user interface to include an indication that the selected object was selected.

In some embodiments, the user input includes multiple taps of the selected object and the operations further include determining a number of taps from the user input and determining the selected object based on the number of taps, wherein a first tap is associated with a different region than a second tap. In some embodiments, the operations further include responsive to the initial image including the subject, generating a background segment, wherein the subject segment is associated with a foreground region, the background segment is associated with a background region, and pixels in the initial image are associated with the foreground region or the background region and determining that the user input corresponds to the foreground region based on the user input making contact with pixels that are associated with the foreground region. In some embodiments, performing object recognition to identify objects in the initial image includes determining object bounding boxes for each of the objects and the operations further include determining that the user input corresponds to the selected object based on a proximity of the user input to a closest object bounding box. In some embodiments, wherein a CNN performs segmentation and the operations further include providing the initial image and a heatmap of keypoints as input to the CNN and outputting, with the convolutional neural network, segmentation masks that correspond to the sky segment, the subject segment, and the one or more distracting segments.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 is a block diagram of an example architecture of a trained tap-to segment machine-learning model, according to some embodiments described herein.

FIGS. 4A-C illustrates example user interfaces for selecting regions of an image, according to some embodiments described herein.

FIG. 5A illustrates an example initial image of a child sitting on a bench and holding balloons that are partially cut off by a boundary of the initial image, according to some embodiments described herein.

FIG. 5B illustrates an example modified image where the child, the bench, and the balloons are moved to a second location, according to some embodiments described herein.

FIG. 6 illustrates example user interfaces that include options for selecting different regions of the image to change, global presets to apply, a field for providing text, and an example output image, according to some embodiments described herein.

FIG. 7 illustrates an example flowchart of a method of modifications made to an initial image, according to some embodiments described herein.

FIGS. 8A-8B illustrate an example flowchart of a method to segment an initial image, according to some embodiments described herein.

### DETAILED DESCRIPTION

As techniques for editing images improve, it becomes increasingly important to intuitively translate user intent to object selection in a user interface. Previous software applications for editing images perform segmentation of an object in an image after a user selects the object. This may result in unnecessary delay while the software application performs the segmentation. In addition, software applications may attempt to correct the delay caused by segmentation by using a less precise, but faster process for performing the segmentation. Less precise segmentation may result in improper identification of the borders of an object where pixels associated with a background or other objects are misclassified as belonging to the object. If an edit includes moving an object, the object may look out-of-place in a new location when the object includes pixels associated with the background from a previous location.

The media application performs preprocessing on an initial image before user interaction to identify a set of objects in the initial image. For example, the media application performs object recognition to identify a subject (e.g., a person, a dog, a child, etc.), trees, bystanders, a sky, etc. The media application performs segmentation of different objects based on a likelihood of the objects being selected by a user. For example, if an initial image is of an outdoor scene, a user may select the sky and change the color of the sky, remove the clouds, etc.

The media application determines whether the initial image is an outdoor scene based on the object recognition. Responsive to the initial image being an outdoor scene, the media application determines a sky segment from the initial image where pixels corresponding to the sky are identified as sky pixels. The media application determines whether the initial image includes a subject that is human or animal based on the object recognition. Responsive to the initial image including the subject, the media application determines a subject segment from the initial image where pixels corresponding to the subject are identified as subject pixels. The media application determines whether the initial image includes one or more distracting objects. Responsive to the initial image including one or more distracting objects, the media application determines one or more distracting segments from the initial image where pixels corresponding to the sky are identified as distracting object pixels. In some embodiments, the distracting objects are identified based on being the types of objects that are frequently removed from initial images.

The media application receives, at a user interface that includes the initial image, user input corresponding to selection of a selected object from the set of objects that were identified based on performing object recognition. For example, the user may select the subject and provide a textual request to add a hat to the subject, select a bystander and ask that the bystander be removed from the image, select an incomplete object that was cut off by a border of the initial image and move the incomplete object to a new location, resulting in the media application generating a complete object for the new location. The media application updates the user interface to include an indication that the selected object was selected. For example, the indication may include a highlighted object, an outline around the selected object, etc.

By performing segmentation before the user input is received, the media application advantageously reduces the processing time that a user waits for segmentation to occur and improves the quality of the segmentation, resulting in output images where background pixels are not improperly associated with selected objects.

### Example Environment 100

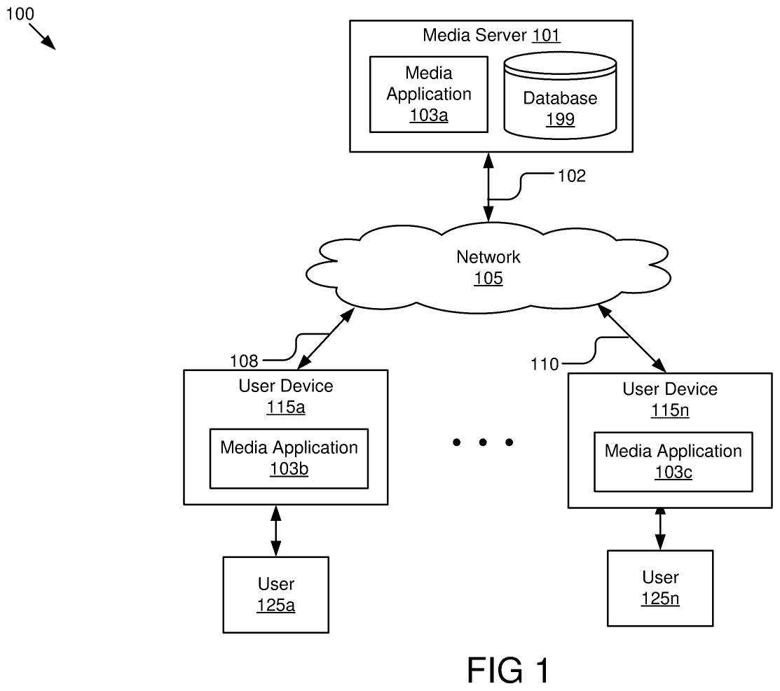

FIG. 1 illustrates a block diagram of an example environment 100. In some embodiments, the environment 100 includes a media server 101, a user device 115a, and a user device 115n coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. In some embodiments, some operations may be performed on the media server 101 and some may be performed on the user device 115. Performance of operations is in accordance with user settings. For example, the user 125a may specify settings that operations are to be performed on their respective user device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., neural networks or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 performs object recognition on an initial image to identify a set of objects in the initial image. The media application 103 determines whether the initial image is an outdoor scene. Responsive to the initial image being an outdoor scene, the media application 103 determines a sky segment from the initial image. The media application 103 determines whether the initial image includes a subject that is human or animal. Responsive to the initial image including the subject, the media application 103 determines a subject segment from the initial image. The media application 103 determines whether the initial image includes one or more distracting objects. Responsive to the initial image including one or more distracting objects, the media application 103 determines one or more distracting segments from the initial image.

The media application 103 receives, at a user interface that includes the initial image, user input corresponding to selection of a selected object from the set of objects. The media application 103 updates the user interface to include an indication that the selected object was selected.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Example Computing Device 200

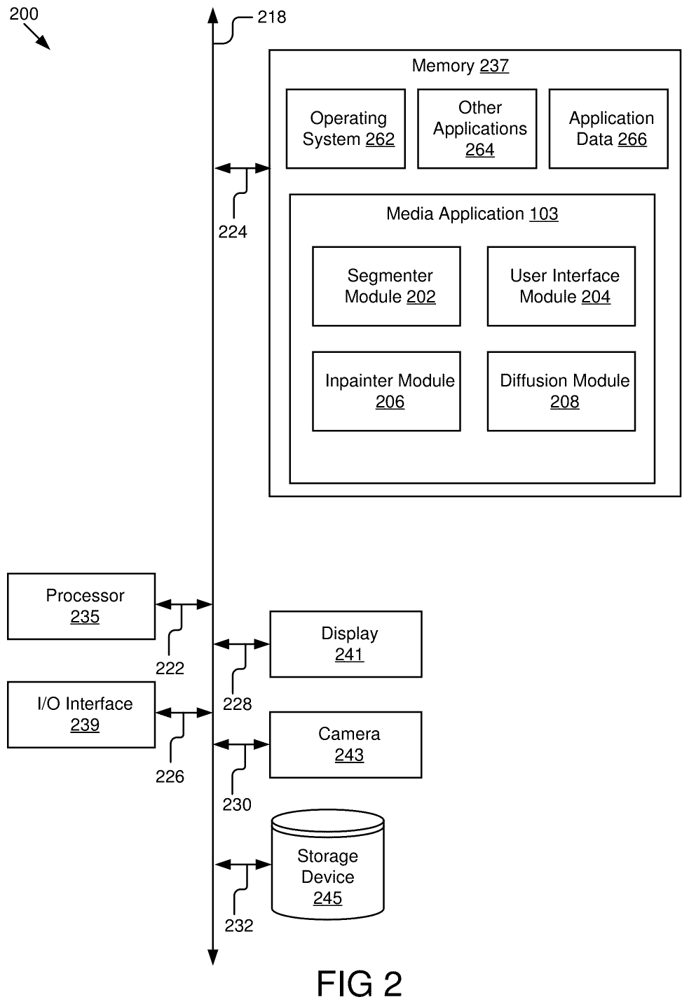

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a segmenter 202, a user interface module 204, an inpainter module 206, and a diffusion module 208.

Segmentation is the process of labelling pixels in an initial image to be associated with a particular class. Segmentation may be used for a variety of reasons. For example, segmentation may be used to identify objects in an image that the user wants to remove, such as bystanders, power lines, scooters, etc. Segmentation may also be used to select objects for enhancement. For example, a user may want to change a background of the image or replace a subject's clothing in the image. Segmentation may also be used to identify regions of an initial image to be preserved by generating a preserving mask that includes pixels associated with an object that are prevented from being modified with blended with a synthetically-generated image.

Once the pixels are labelled, the output of segmentation is one or more segmentation masks that include pixels associated with segmented objects or regions in the initial image. The segmentation mask may be used as a grouping of pixels associated with objects or regions such that when a user interface receives user input, the user interface module 204 determines whether the user input corresponds to a particular segmentation mask based on the location of the user input. For example, the user interface module 204 may identify that the user input touched a number of pixels that are associated with a background segmentation mask. The segmentation mask may be used as a preserving mask to prevent modification to pixels associated with the preserving mask while pixels that are not associated with the preserving mask are modified. For example, during the process of generating an output image with a diffusion model, a preserving mask is used on a face of a subject to prevent the face from becoming distorted during generation of the output image.

The segmenter 202 receives an initial image. The initial image may be captured by a camera 243 associated with the computing device 200, received from other applications 264, etc. The segmenter 202 performs object recognition on the initial image to identify a set of objects in the initial image. The object recognition may be performed by a machine-learning model or another algorithm. In some embodiments, the segmenter 202 determines object bounding boxes for each of the objects in the set of objects. The object bounding boxes may include pixels associated with particular objects and be associated with metadata describing the object bounding boxes, such as (x, y) coordinates that describe the edges of the object bounding boxes.

The segmenter 202 performs segmentation of the initial image. For example, the segmenter 202 identifies pixels associated with a subset of the set of objects in the initial image based on object recognition and a likelihood that the subset of objects will be selected by a user. The likelihood that the subset of objects will be selected by a user may be based on anonymized information about what people select in an image. For example, users may be most likely to select the subject of an image, likely to select distracting objects in an image, and least likely to select aesthetic background objects, such as trees, buildings in a cityscape, boats on the ocean, etc.

In some embodiments, the segmenter 202 determines whether the initial image has particular types of objects and performs segmentation responsive to the initial image including the particular types of objects. For example, the segmenter 202 determines whether the initial image is an outdoor scene based on object recognition identifying the presence of a sky. An outdoor scene is characterized by an image that includes a sky. In some embodiments, the segmenter 202 determines that the initial image is an outdoor scene based on the initial image including certain colors associated with an outdoor scene and/or certain colors being located in regions where a sky is expected. The outdoor scene may include additional objects, such as buildings, trees, beaches, etc. If the initial image is an outdoor scene, the segmenter 202 determines a sky segment for the initial image.

The segmenter 202 determines whether the initial image includes a subject that is human or animal based on object recognition identifying objects that are associated with the human and/or animal category. For example, the subject may be a cat, a chicken, a person, etc. If the initial image includes a subject that is human or animal, the segmenter 202 determines a subject segment from the initial image.

The segmenter 202 determines whether the initial image includes one or more distracting objects. Distracting objects may be based on types of objects that are frequently removed from initial images, such as people that are not subjects of the initial image, cars, powerlines, etc. Conversely, the segmenter 202 may not segment objects, such as trees because trees are not frequently removed from initial images. In some embodiments, the classification of an object as a distracting object is based on a ranking of types of objects that are removed from initial images with a cutoff value (e.g., the top 20 most frequently removed objects are classified as types of distracting objects, a likelihood that exceeds a threshold likelihood value that a type of object will be removed from an initial image, etc.). If the initial image includes one or more distracting objects, the segmenter determines one or more distracting segments from the initial image.

In some embodiments, segmentation also includes foreground/background segmentation, sky segmentation, and/or panoptic segmentation (e.g., segmenting the image into semantically meaningful parts or regions). The foreground/background segmentation may be used by media applications 103 that perform selective tone mapping. Tone mapping is used to modify the tonal values of pixels. Tone mapping may be used to adjust the tonal values of an initial image with a high dynamic range for applications, such as viewing on digital displays.

The segmenter 202 may use different approaches for segmenting the subset of the objects in the image. In some embodiments, the segmenter 202 segments objects into regions. In some embodiments, the segmenter 202 divides an image into a foreground and background and segments objects based on whether they are located in the foreground or the background.

In some embodiments, the segmenter 202 generates different kinds of segmentation masks for segmentation performed on the image. For example, the segmenter 202 may generate a subject mask that preserves the subject's face, or includes more of the subject, such as an entire head, hands, a body of the subject, etc. In some embodiments, the segmentation mask is generated based on generating superpixels for the image and matching superpixel centroids to depth map values (e.g., obtained by the camera 243 using a depth sensor or by deriving depth from pixel values) to cluster detections based on depth. More specifically, depth values in a masked area may be used to determine a depth range and superpixels may be identified that fall within the depth range.

Another technique for generating a segmentation mask includes weighing depth values based on how close the depth values are to the mask where weights were represented by a distance transform map.

In some embodiments, the segmenter 202 may specify a circuit configuration (e.g., for a programmable processor, for a field programmable gate array (FPGA), etc.) enabling processor 235 to apply a machine-learning model. In some embodiments, the segmenter 202 may include software instructions, hardware instructions, or a combination. In some embodiments, the segmenter 202 may offer an application programming interface (API) that can be used by the operating system 262 and/or other applications 264 to invoke the segmenter 202 e.g., to apply the machine-learning model to application data 266 to output the segmentation mask.

The segmenter 202 uses training data to generate a trained machine-learning model. In some embodiments, the training data includes images (e.g., Red Green Blue (RGB) images) and heatmaps of keypoints in the images. The keypoints are distinctive or salient points in an initial image that are used to identify, describe, or match objects or features in the scene. For example, keypoints may be determined using a Scale Invariant Feature Transform (SIFT). In some embodiments, the training data also includes corresponding segmentation masks.

Training data may be obtained from any source, e.g., a data repository specifically marked for training, data for which permission is provided for use as training data for machine learning, etc. In some embodiments, the training may occur on the media server 101 that provides the training data directly to the user device 115, the training occurs locally on the user device 115, or a combination of both.

In some embodiments, the segmenter 202 uses weights that are taken from another application and are unedited/transferred. For example, in these embodiments, the trained model may be generated, e.g., on a different device, and be provided as part of the segmenter 202. In various embodiments, the trained model may be provided as a data file that includes a model structure or form (e.g., that defines a number and type of neural network nodes, connectivity between nodes and organization of the nodes into a plurality of layers), and associated weights. The segmenter 202 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (CNN) (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of an initial image. Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the initial image into a foreground and a background and output whether a pixel is part of a segmentation mask or not. In some embodiments, model form or structure also specifies a number and/or type of nodes in each layer.

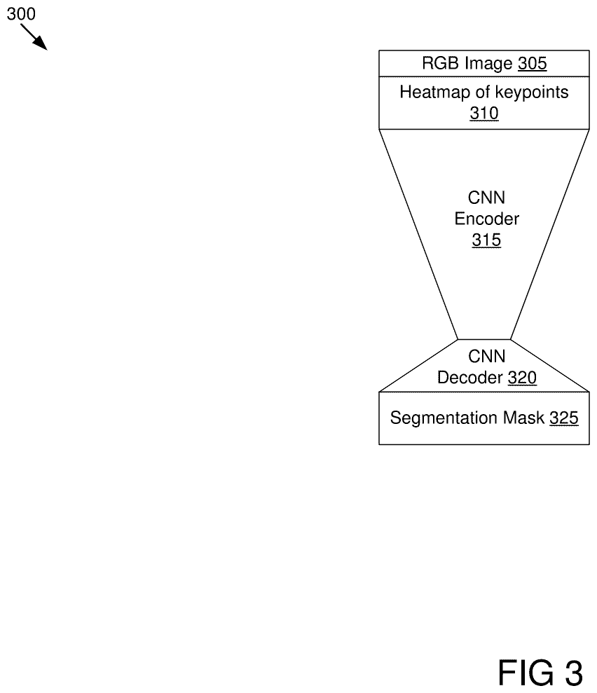

FIG. 3 is a block diagram of an example architecture 300 of a trained tap-to segment machine-learning model, according to some embodiments described herein. The example architecture includes a CNN that receives input and generates output. A CNN includes convolutional layers that apply filters to input data to extract features. The convolutional layers may be followed by pooling layers to reduce spatial dimensions and increase computational efficiency.

The CNN includes a CNN encoder 315 and a CNN decoder 320. Encoders receive images and encode the images into a vector or matrix representation of the image. The CNN encoder 315 receives an RGB image 305 and corresponding heatmaps of keypoints 310. An RGB image 305 is an image that includes pixels containing one of the three color channels: Red, Green, and Blue. Keypoints 310 include the locations within an initial image where users make contact. The keypoints 310 may be defined as locations where user input exceeds a threshold user input value.

The CNN encodes the RGB image 305 into increasingly abstracted information where each convolutional layer represents a different level of abstraction. The CNN decoder 320 decodes the abstracted information and outputs a segmentation mask 325 that identifies pixels that are associated with one or more objects in the RGB image 305. For example, the RGB image 305 may be an image of a coffee mug on a table and the heatmap of keypoints 310 has a keypoint in the center of the coffee mug to indicate that users typically select the coffee mug and nothing else in the image. The CNN decoder 320 outputs a segmentation mask that segments the coffee mug from the rest of the image since the user is likely to tap on the coffee mug and not other objects in the image.

In different embodiments, the trained model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., images, segmentation masks, etc.) and a corresponding groundtruth output for each input (e.g., a groundtruth mask that correctly identifies a portion of the subject, such as the subject's face, in each image). Based on a comparison of the output of the model with the groundtruth output, values of the weights are automatically adjusted, e.g., in a manner that increases a probability that the model produces the groundtruth output for the image.

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 202 may generate a trained model that is based on prior training, e.g., by a developer of the segmenter 202, by a third-party, etc. In some embodiments, the trained model may include a set of weights that are fixed, e.g., downloaded from a server that provides the weights.

In some embodiments, the trained machine-learning model receives an initial image with objects that were identified by object recognition. In some embodiments, the trained machine-learning model outputs one or more segmentation masks that correspond to the one or more of the objects. For example, the trained machine-learning model outputs segmentation masks for a sky, a subject, and one or more distracting objects. In another example, the trained machine-learning model outputs segmentation masks for a background and a foreground.

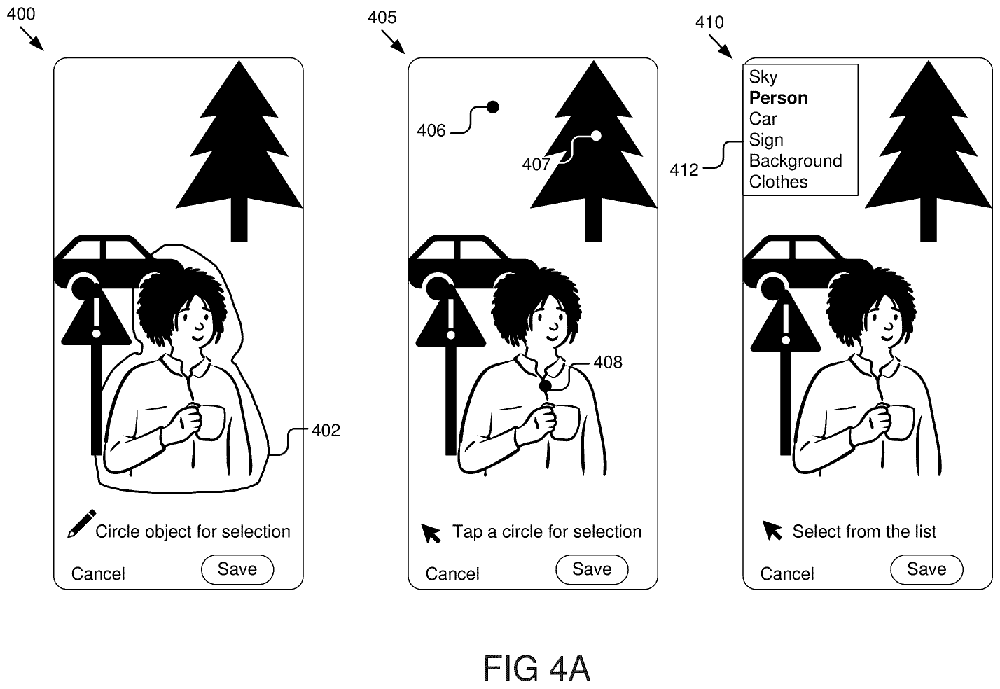

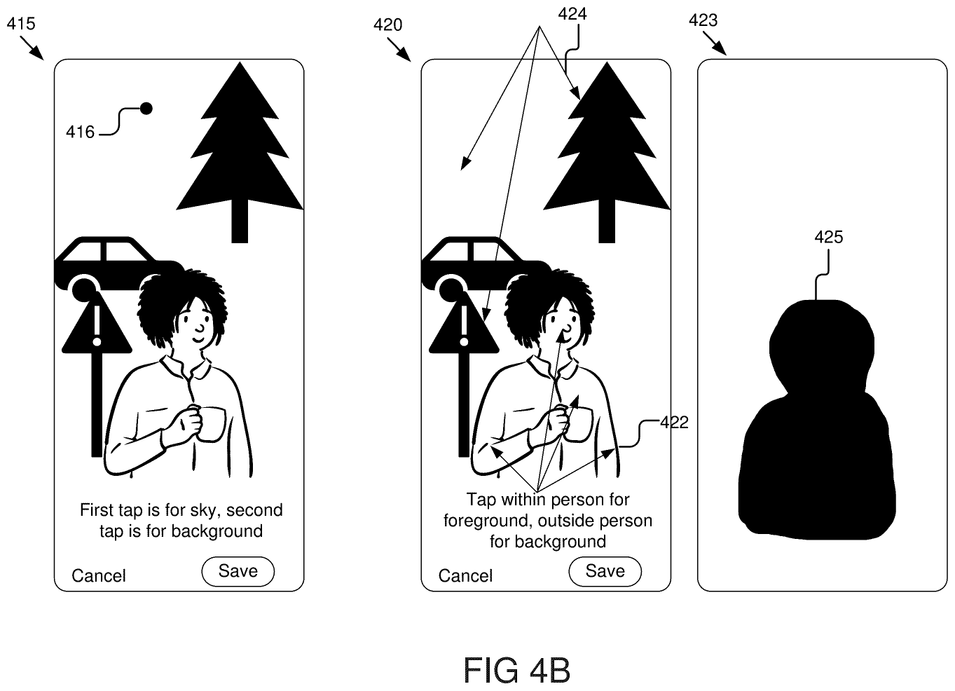

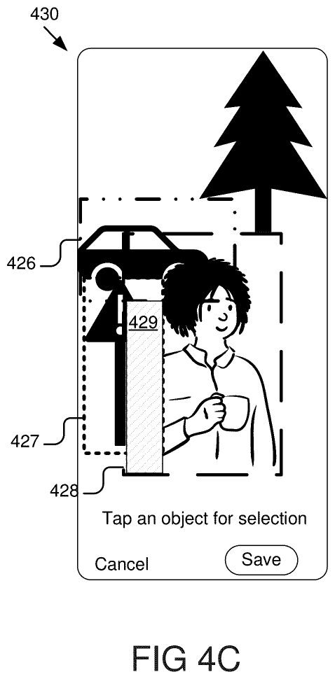

The user interface module 204 generates graphical data for displaying a user interface that includes images. The user interface displays different options for associating user input with a corresponding region in the image. FIGS. 4A-C illustrates example user interfaces for selecting regions of an image, according to some embodiments described herein.

FIG. 4A includes a first user interface 400 where a user is instructed to circle any object that the user wants to select, according to some embodiments described herein. This may be referred to as a stroke selection. In this example, the user has circled 402 the subject in the image. In the second user interface 405, the user is instructed to tap one of the circles to select the object. For example, the user may select circle 406 to select the sky, circle 407 to select the tree, circle 408 to select the user, etc. In the third user interface 410, the user is instructed to select one of the regions/objects from the list 412 of sky, person, car, sign, background, and clothes. The “Person” in the list 412 is highlighted as an indication to show that the user selected the person.

FIG. 4B includes a fourth user interface 415 where a single circle is associated with multiple regions/objects, according to some embodiments described herein. In this example, circle 416 can be selected a first time to select the sky and circle 416 can be selected a second time to select the background. In response to the user selecting the circle 416 once, the user interface module 204 may update the user interface to display a segment mask to indicate the pixels associated with a sky segment. In response to the user selecting the circle 416 twice, the user interface module 204 may update the user interface to display a segment mask to indicate the pixels associated with a background segment.

In the fifth user interface 420, the segmenter 202 has segmented the image into a foreground segment and a background segment. The person is in the foreground and everything else is in the background. As a result, selecting any area within the foreground region, as illustrated by the example foreground arrows 422, results in a selection of the person. Selecting any area within the background region, as illustrated by the background arrows 424, results in a selection of the background.

In the sixth user interface 423, a user selected pixels corresponding to the foreground segment in the fifth user interface 420 and the user interface module 204 updated the user interface to include an indicator that is a segmentation mask 425 associated with the foreground segment.

FIG. 4C includes a seventh user interface 430 where a user may tap on an object to select the corresponding object. The objects are associated with object bounding boxes. If a user taps within a bounding box, the object is selected. For example, tapping within bounding box 426 results in a selection of the car. Tapping within bounding box 427 results in selection of the stop sign. This scenario may result in some confusion, for example, when the user taps on a section that is within two bounding boxes such as a region 429 where bounding box 427 and bounding box 428 overlap. In some embodiments, if a selection is ambiguous, the user interface may display text asking the user for confirmation about which object the user intended to select or the user interface may update the display to provide an indicator of which object it is more likely that the user intended to select, which the user can change if the user disagrees.

Once the user interface module 204 determines what object/region the user input corresponds to, the user interface module 204 generates graphical data for displaying an indicator that the object was selected. For example, the user interface may add an outline around the selected object, highlight the selected object, etc.

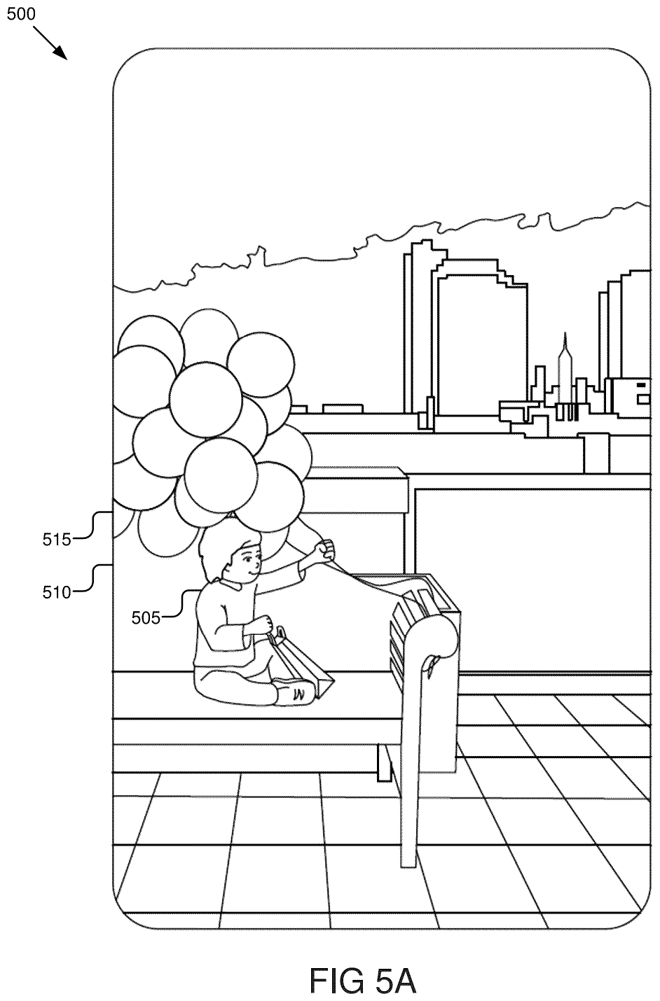

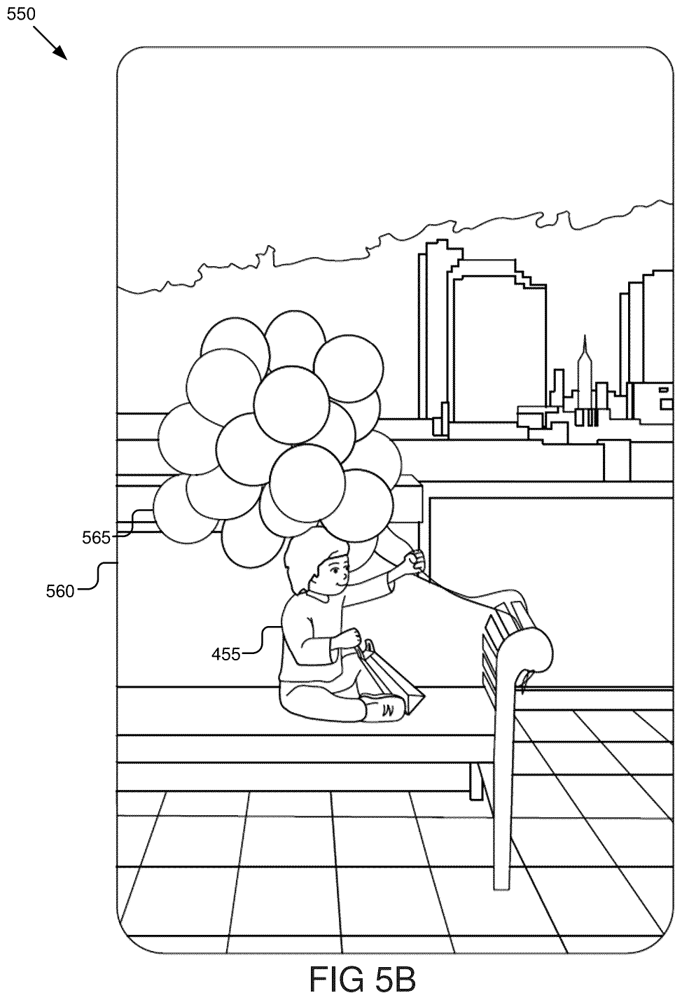

FIG. 5A illustrates an example initial image 500 of a child 505 sitting on a bench 510 and holding balloons 515 that are partially cut off by a boundary of the initial image 500, according to some embodiments described herein. In this example, a user interface module 204 provides a user interface with an option for a user to select objects that were segmented by the segmenter 202. The user selects the child 505, the bench 510, and the balloons 515 at a first location, where the balloons 515 represent an incomplete image.

The user interface module 204 includes an option for moving the selected objects to a different location. The user selects a second location. The segmenter 202 removes the selected objects from the initial image. An inpainter module 206 generates an inpainted image that replaces object pixels corresponding to removed objects with background pixels that match a background in the initial image.

A diffusion module 208 receives as input the selected objects and coordinates for the second location and outputs balloons that are complete objects and a longer bench. FIG. 5B illustrates an example modified image 550 where the child 555, the bench 560, and the balloons 565 are moved to a second location, according to some embodiments described herein. In this example, the diffusion module 208 outputs a modified image that blends one or more versions of the child 555, the bench 560, and the balloons 565 with one or more versions of the inpainted image using a segmentation mask.

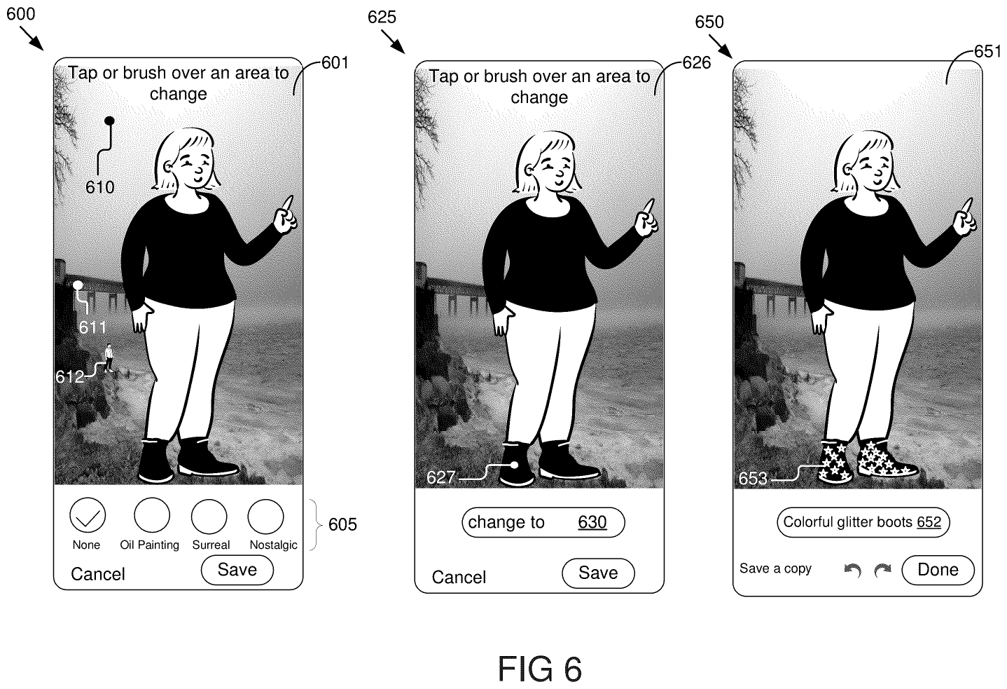

FIG. 6 illustrates example user interfaces 600, 625, 650 that include options for selecting different regions of the image to change, global presets to apply, a field for providing text, and an example output image, according to some embodiments described herein. Specifically, the first user interface 600 automatically provides global presets 605 for a user to select to change an input image 601 to look like an oil painting, a surreal world, or a nostalgic scene.

The first user interface 600 also includes circles 610, 611, 612 that represent identifications of different regions in the initial image 601. The user can specify changes that are made to the sky by tapping the first circle 610, to the bridge by tapping the second circle 611, and to the person by tapping the third circle 612.

In response to the user selecting one of the circles 610, 611, 612, the user interface may update the display to provide a menu of options (not shown). For example, selecting the first circle 610 may cause the user interface to display suggestions, such as changing the cloudy sky to a clear sky. Selecting the second circle 611 may cause the user interface to display suggestions, such as an option to remove the bridge associated with the second circle 611, an option to replace the bridge with a different type of bridge or a boat, etc. Selecting the third circle 612 may cause the user interface to display a suggestion remove the person.

The second user interface 625 includes an input image 626 and a text input field 630 where the user can specify changes that they want made. The user can either include a description specific enough to encompass the objects that the user wants to be changed (e.g., change the boots to colorful glitter boots) or the user can select an object in the second user interface 625 that the user wants to be changed and then describe the particular changes to be made. For example, a user may select an object by tapping on the object, circling the object, scribbling on the object, etc. In this case, a user selects a boot 627 on the subject.

The third user interface 650 includes an output image 651 where the text request 652 of “colorful glitter boots” is fulfilled. The boots 653 are changed to be sparkly colorful stars.

For situations where an object is removed from the initial image, an inpainter module 206 generates an inpainted image that replaces object pixels corresponding to one or more objects with background pixels. The background pixels may be based on pixels from a reference image of the same location without the objects. Alternatively, the inpainter module 206 may identify background pixels to replace the removed object based on a proximity of the background pixels to other pixels that surround the object. The inpainter module 206 may use a gradient of neighborhood pixels to determine properties of the background pixels. For example, where a bystander was standing on the ground, the inpainter module 206 replaces the background pixels with pixels of the ground. Other inpainting techniques are possible, including a machine-learning based inpainter technique that outputs background pixels based on training data that includes images of similar structures.

In embodiments where a user chose to erase the selected object, the user interface module 204 may display the inpainted image where the selected object was removed and the selected object pixels were replaced with background pixels.

Diffusion models include a forward process where the diffusion model adds noise to the data and a reverse process where the diffusion model learns to recover the data from the noise. For example, where a selected object is moved from a first location to a second location, the diffusion module 208 applies the diffusion model by blending the selected object with progressively noisier versions and then progressively denoised versions of the inpainted image. In some embodiments, an object stitch diffusion model is used to move an object from a first location to a second location. In some embodiments, a generation diffusion model is used when the object is an incomplete object and a portion of the object is generated and/or for new objects that are generated from text prompts.

### Object Stitch Diffusion Model

In some embodiments, the object stitch diffusion model is used when an object is moved from a first location to a second location. In some embodiments, the diffusion module 208 includes an object image encoder that extracts semantic features from a selected object, a diffusion model that blends an object with an image, and a content adaptor that transforms a sequence of visual tokens to a sequence of text tokens to overcome a domain gap between image and text. In some embodiments, the diffusion module 208 trains the diffusion model using self-supervision based on training data where the training data includes image and text pairs. In some embodiments, the diffusion model is trained on synthetic data that simulates real-world scenarios. The diffusion model may also be trained using data augmentation that is generated by introducing random shift and crop augmentations during training, while ensuring that the foreground object is contained within the crop window.

The content adaptor is trained during a first stage using the image and text pairs to maintain high-level semantics of the object and during a second stage the content adaptor is trained in the context of the diffusion model to encode key identity features of the object by encouraging the visual reconstruction of the object in the original image. The diffusion model may be trained on an embedding produced by the content adaptor through cross-attention blocks.

The diffusion model uses a preserving mask to blend the inpainted image with the object. The diffusion model may denoise the masked area. The content adaptor may transform the visual features from the object image encoder to text features (tokens) to use as conditioning for the diffusion model.

### Generative Diffusion Model

In some embodiments, the generative diffusion model is used to output a complete object based on an incomplete object or to generate a new object. The diffusion module 208 trains the generative diffusion model based on training data. The training data may include image and text pairs that are used to create an embedding space for images and text. The image and text pairs may include an image that is associated with corresponding text, such as an image of a dog and text that includes “pitbull.” The diffusion module 208 may be trained with a loss that reflects a cosine distance between an embedding of a text prompt and an embedding of an estimated clean image (i.e., with no text-generated objects).

The diffusion module 208 may use the training data to perform text conditioning, where text conditioning describes the process of outputting objects that are conditioned on a text prompt. The diffusion module 208 may train a neural network to output the object based on the text prompt provided by a user or by the media application. For example, the text prompt may be a suggestion generated by the media application based on the context of the initial image (e.g., where the initial image is a beach, the text prompt may be for a beach ball, a turtle, etc.).

In some embodiments, the diffusion module 208 may output at least a portion of a missing part of an object based on receiving an incomplete object as input data, a location within the image where the incomplete object is being moved, and dimensions of the output (e.g., the original dimensions or modified dimensions if the object is resized). For example, if a user selects an object in a user interface that is partially cut off by a boundary and moves the object from a first location to a second location where the second location also cuts off part of the object, the diffusion module 208 may output a modified object that includes more of the object that is visible based on moving the object in the image. In some embodiments, the diffusion module 208 may output a complete object based on an incomplete object selected by a user. For example, where a user selected a beach ball that is partially obscured by another object, the diffusion model may be trained to output a complete beach ball.

In some embodiments, the diffusion module 208 generates progressively noisier versions of the complete object as compared to a previous version and progressively noisier versions of the inpainted image as compared to a previous version. For example, a forward Markovian noising process produces a series of noisy inpainted images by gradually adding Gaussian noise until a nearly isotropic Gaussian noise sample is obtained. The forward noising process defines a progression of image manifolds, where each manifold consists of noising images.

The diffusion module 208 may spatially blend noisy versions of the complete object with corresponding noisy versions of the inpainted image using the preserving mask. For example, the diffusion module 208 may blend each noisy version of the complete object with each corresponding noisy version of the inpainted image using the preserving mask where the preserving mask delineates the boundaries of the complete object such that the preserving mask delineates the area that is modified during the blending process. In some embodiments, the diffusion process may include a local complete-object guided diffusion where the image generation loss determined during the training process is used under the preserving mask during location object-generation diffusion.

The diffusion module 208 may perform a diffusion step that denoises a latent space in a direction dependent on a text prompt. The diffusion module 208 generates progressively denoised versions of the complete object as compared to a previous version and progressively denoised versions of the inpainted image as compared to a previous version. For example, the reverse Markovian process transforms a Gaussian noise sample by repeatedly denoising the inpainted image using a learned posterior. Each step of the denoising diffusion process projects a noisy image onto the next, less noisy manifold.

The diffusion module 208 performs the denoising diffusion step after each blend to restore coherence by projecting onto the next manifold. Once the spatial blending is complete, the diffusion module 208 preserves the background by replacing a region outside the preserving mask with a corresponding region from the inpainted image.

In some embodiments, the diffusion module 208 uses cross-domain compositing to apply an iterative refinement scheme to infuse an object with contextual information to make the object match the style of the inpainted image. For example, if the object is generated for an indoor setting and is added to an outdoor inpainted image, the object may be modified to be brighter to match the inpainted image. In another example, if the object was located at a first location in a shadow and the second location is in full sun, the object may be modified to match the brightness of the second location.

### Object Removal Model

In some embodiments, instead of using the segmenter 202 to remove an object and using the inpainter module 206 to add pixels to the removed area in an initial image, the diffusion model is trained to include an object removal model.

The diffusion module 208 generates counterfactual training data to train the diffusion model to include an object removal model. For each counterfactual image pair, the diffusion module 208 captures a factual image that contains an object in a scene; physically removes the object while avoiding camera movement, lighting changes, or motion of other objects; captures a counterfactual image of the scene without the object, and segments the factual image to create a preserving mask. Segmenting the factual image includes creating a segmentation map (Mₒ) for the object O removed from the factual image X.

The diffusion module 208 creates, for each image pair, a combined image that includes the factual image and the preserving mask and the counterfactual image. The preserving mask may be binary preserving mask (Mₒ(X)) and the counterfactual image pairs may be described as an input pair of the factual image and the binary preserving mask (X, Mₒ(X)), and the output counterfactual image (X^{cf}).

The diffusion module 208 estimates the distribution of the counterfactual images P(X^{cf}|X=x,Mₒ(X)) given the factual image x and the binary preserving mask by training the diffusion model based on using the counterfactual image pairs. The diffusion module 208 determines the estimation by minimizing a loss function [symbol] (θ) using the following equation:

$$ℒ ( θ ) = 𝔼 [ {\sum }_{i = 1}^{N} {‖ {D}_{θ} ( {α}_{i} {x}_{i}^{cf} + {σ}_{t} ϵ , {x}_{i} , {M}_{o} ( {x}_{i} ) , t , p ) - ϵ ‖}^{2} ] \qquad Eq . 1$$

where D_{θ}(\tilde{x}ₜ,x_{cond},m,t,p) is a denoisier network with the following inputs: noised latent representation of the counterfactual image \tilde{x}ₜ, latent representation of the image containing the object to be removed x_{cond}, mask m indicating the object's location, timestamp t, and encoding of an empty string (text prompt) p. xₜ is calculated using the following forward process equation:

$${x}_{t} = {α}_{t} \cdot x + {σ}_{t} \cdot ϵ \qquad Eq . 2$$

where x represents the image without the object (the counterfactual), αₜ and σₜ are determined by the noising schedule, and ∈˜ [symbol] (O, I).

Once the diffusion model including an object removal model is trained, the user interface module 204 may receive a request to remove a selected object from the first modified image. An initial image and the request are provided as input to the object removal model, which outputs a modified image that does not include the selected object.

### Object Insertion Model

In some embodiments, instead of using the segmenter 202 to remove an object, using the inpainter module 206 to add pixels to the removed area in an initial image, and using the diffusion model to blend the object with the pixels at a new location, the diffusion model is trained to include an object insertion model.

In some embodiments, the object insertion model is trained on a number of image pairs that exceed the number of counterfactual image pairs that are available. As a result, the diffusion module 208 generates synthetic training data. For each synthetic image pair, the diffusion module 208 selects original images that include objects, uses the object removal model to output modified images from the original images without the objects, generates an input image by inserting the object into the modified image, and segments the original image to create the preserving masks. The modified images that lack the objects are referred to as za using the following equation:

$${z}_{i} \sim P ( {X}^{cf} \vert {x}_{i} , {M}_{o} ( {x}_{i} ) ) \qquad Eq . 3$$

where the original images are x₁, x₂ . . . , xₙ and the corresponding preserving masks are Mₒ(x₁), Mₒ(x₂), . . . , Mₒ(xₙ). The diffusion module 208 generates the input image by inserting the object into object-less scenes zᵢ to result in images without shadows and reflections using the following equation:

$${y}_{i} = {M}_{o} ( {x}_{i} ) ⊙ {x}_{i} + ( 1 - {M}_{o} ( {x}_{i} ) ) ⊙ {z}_{i} \qquad Eq . 4$$

The synthetic image pairs are (yᵢ,Mₒ(xᵢ)) and the corresponding targets are the original images xᵢ. While both the input images and the output images contain the object o, the input images do not contain the effects of the object on the scene, while the output images do. In some embodiments, the diffusion module 208 trains the object insertion model with the diffusion objective presented in Equation 1.

For each synthetic image pair, the diffusion module 208 creates a second combined image that includes the original image and the preserving mask and the input image. The diffusion module 208 pre-trains the diffusion model to include an object insertion model based on using synthetic image pairs and fine-tunes the diffusion model to include the object insertion model based on using the counterfactual image pairs used to train the object removal model.

In some embodiments, the user interface module 204 generates graphical data for displaying a user interface that provides the user with the option to specify the location of the object and the option to resize the object. The diffusion module 208 adds a selected object that was removed from the initial image to the new location. In some embodiments, the diffusion module 208 provides the selected object as input to a diffusion model, as well as a location where the selected object will be located in a modified image, and outputs a modified image that blends the selected object with the inpainted image. For example, the diffusion module 208 may spatially blend noisy versions of the inpainted image with noisy versions of the selected object.

In some embodiments, the diffusion module 208 may add a shadow to the selected object in the new location. The shadow may match a direction of light in the image. For example, if the sun casts rays from the upper left-hand corner of the image, the shadow may be displayed to the right of the person and/or object. In some embodiments, the diffusion module 208 uses a machine-learning model to output a shadow mask that is used to generate the shadow attached to the object.

### Diffusion Model for Textual Requests

In some embodiments, a user may select an object or region and provide a request to change the selected object or region. For example, the user may select a subject to change the subject's outfit or a sky to change the lighting of the sky. The diffusion model receives the request (e.g., a textual request provided directly by the user, a selection of a premade prompt, a selection of a global preset, a selection of an option from a menu, etc.), the initial image, and a preserving mask as input. The diffusion model encodes images in latent space, performs the diffusion, and decodes back to pixel space.

The diffusion module 208 performs text conditioning of the request. Text conditioning describes the process of generating images that are conditioned on (e.g., aligned with) a text prompt. For example, if the text request is for replacing a red shirt that a subject is wearing in the initial image with a blue shirt, the diffusion module 208 performs text conditioning by generating an output image of a blue shirt.

In some embodiments, the diffusion module 208 trains the diffusion model using two types of training data. The first type of training data includes pairs of images where the pairs may include synthetic pairs generated through a prompt-to-prompt generative machine-learning model. The prompt-to-prompt generative machine-learning model is a diffusion model that receives a text prompt and uses self-attention to extract keys and values from the text prompt and switch parts of an attention map previously generated for an input image based on the inputted text prompt to output an output image to match the text prompt.

The prompt-to-prompt generative machine-learning model generates self-attention maps. Self-attention computes the interactions between different elements of an input sequence (e.g., the different words in a textual request). This is contrasted with cross-attention where the interactions are between two different input sequences (e.g., how the textual request relates to an original prompt.

Self-attention maps describe the structure and different semantic regions in an image. For example, an image that is described as “pepperoni pizza next to orange juice,” in a self-attention map includes how a pixel on a crust of the pizza attends to other pixels on the crust. Conversely, in a cross-attention map a pixel on the crust of the pizza attends to the orange juice.

Self-attention maps are used in a text-conditional diffusion model to use the structure and different sematic regions in an input image to change one or more token values, while fixing the self-attention maps to preserve the scene composition. In some embodiments, the diffusion model adds new words to the prompt and freezes the attention on previous tokens while allowing new attention to flow to the new tokens. This results in global editing or modification of a specific object in the input image to match the textual request.

Each diffusion step predicts the noise from a noisy image and text embedding. At the final step the process yields a generated image. The interaction between the text prompt and the image occurs during the noise prediction, where the embeddings of the visual and textual features are fused using self-attention layers that produce spatial attention maps for each textual token.

The second type of training data includes pairs with a real image and a synthetic image. The real image is received by a diffusion model, such as a denoising diffusion implicit model (DDIM). The diffusion model uses an inversion method to output a synthetic image based on the real image and an instruction for how to edit the input image. The diffusion module 208 trains the diffusion model to generate output images from a request using a forward process where the diffusion model adds noise to the data and a reverse process where the diffusion model learns to recover the data from the noise.

The diffusion module 208 trains the diffusion model to maintain photorealism and to preserve the identity of the objects shown in the image. During training, the diffusion model receives edit instructions and modifies the edit instructions to create corresponding prompts based on a language model, such as a large language model. For example, the diffusion module 208 converts, using the language model, the edit instructions “make person look like an astronaut” to prompts describing various aspects of how clothing for a space suit would look.

The diffusion model creates a set of input and output image pairs from the generated prompt pairs where each prompt can generate N number of images (using different seeds). The diffusion module 208 filters certain images from the image pairs, such as image transformations that do not match the given edit instruction, image transformations that do not produce well-aligned images, and pairs that do not match. In some embodiments, the diffusion module 208 also filters images based on an edit alignment score that reflects an alignment between the image-to-image transformation and the original edit caption and an image-text alignment score that reflects an alignment between the input/output image and the corresponding input/output prompt. In some embodiments, the diffusion module 208 trains the diffusion model by generating one or more loss functions based on the images that are filtered from the image pairs.

Diffusion models are trained to generate images by progressively adding noise to images, which the diffusion model then learns how to progressively remove. The diffusion model applies the denoising process to random seeds to generate realistic images. By simulating diffusion, the diffusion model generates one or more noisy images.

Once the diffusion model is trained, the diffusion model receives an input image and performs an inverse diffusion process on the initial image to generate a noisy image based on the initial image. In some embodiments, the diffusion module 208 performs the inverse diffusion using a DDIM inversion.

The diffusion model provides the noisy image to a first CNN with a feature and self-attention mechanism. The first CNN samples the input image and extracts features from the input image. The first CNN directly injects the extracted features and self-attention maps into a second CNN. The first CNN performs forward diffusion of the noisy initial image, which is the process of progressively denoising the noisy image using sampling to output a denoised initial image.

The text request and the noisy image are provided as input to the second CNN. The second CNN uses the self-attention maps to align the semantic features of the text request with the structure of the noisy image to generate a noisy translated image. The second CNN performs forward diffusion of the noisy translated image to output a denoised translated image.

The denoised initial image is combined with the denoised translated image and the preserving mask. This advantageously prevents modification to the face, which otherwise may be modified in a way that results in unrealistic features. In some embodiments, the diffusion module 208 performs the blending by using a mask smoothing algorithm and Poisson blending.

In some embodiments, the preserving mask includes other parts of the subject, such as the subject's hair if the user wants their hair to remain the same, the subject's fingers since fingers are often modified by machine-learning models in unrealistic ways, the subject's entire body where the subject is a pet to prevent the pet from being overly modified, etc. In some embodiments where the output image modifies the clothing of the subject, the preserving mask may include everything but the subject's clothing so that the body (minus the clothing) and the background of the initial image are preserved.

The combined denoised image and preserving mask are blended with the denoised translated image to form an output image that satisfies the textual request.

### Example Flowcharts

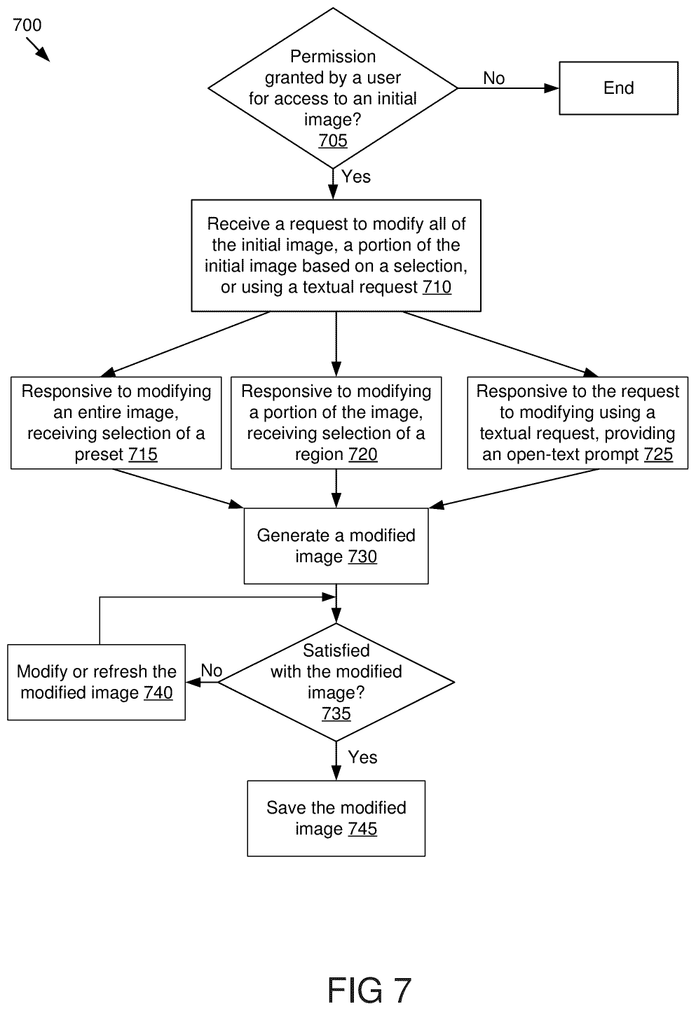

Media applications 103 may include different ways to edit initial images. FIG. 7 illustrates an example flowchart of a method 700 of modifications made to an initial image, according to some embodiments described herein. The method 700 may be performed by the computing device 200 in FIG. 2. In some embodiments, the method 700 is performed by the user device 115, the media server 101, or in part on the user device 115 and in part on the media server 101.

The method 700 of FIG. 7 may begin at block 705. At block 705, it is determined whether a user grants permission for access to an initial image. If the user does not grant permission, the method 700 ends. If the user does grant permission, block 705 may be followed by block 710.

At block 710, a request to modify all of the initial image, a portion of the initial image, or a textual request is received. A modification to all of the initial image may include, for example, a request to change the style of the initial image to look like an impressionist painting. A modification of a portion of the initial image, for example, may include a request to move an object from one place to another,, a request to remove powerlines, etc. A modification that includes a textual request may be directed to a particular object in the image (e.g., a request to replace a subject's shirt with a jacket), directed to creating a new object (e.g., a request to add a turtle to an initial image at the beach), or a change to the entire image (e.g., a request to change an outdoor scene from a daylight image to a moonlight image). Block 710 may be followed by block 715 for modifying an entire image, block 720 for modifying a portion of the image, or block 725 for a textual request.

At block 715, responsive to the request being to modify an entire image, selection of a preset is received. The preset may include changing an outdoor scene to sunset, night, or a cloudy scene, etc.; changing the initial image to an oil painting, surreal, nostalgic, etc.; changing the theme to sea adventurer, ancient warrior, space crusader, wise mage, aristocrat, space mission, etc. Block 715 may be followed by block 730.

At block 720, responsive to modifying a portion of the image, receiving selection of a region. The region may include groups of objects, such as a sky with clouds, or a single object. The region may be selected by clicking on a circle in the user interface, circling a region, tapping on a region until the desired region is highlighted with an indicator, etc. Block 720 may be followed by block 730.

At block 725, responsive to the request to modify using a textual request, an open-text prompt is used. Block 725 may be followed by block 730.

At block 730 a modified image is generated. Block 730 may be followed by block 735.

At block 735, it is determined whether the user is satisfied with the modified image. If the user is not satisfied with the modified image, block 735 may be followed by block 740.

At block 740, responsive to a user providing additional user input, the modified image is modified or refreshed. The cycle from block 735 to block 740 is repeated until the user is satisfied with the modified image, at which point block 735 may be followed by block 745.

At block 745, the modified image is saved.

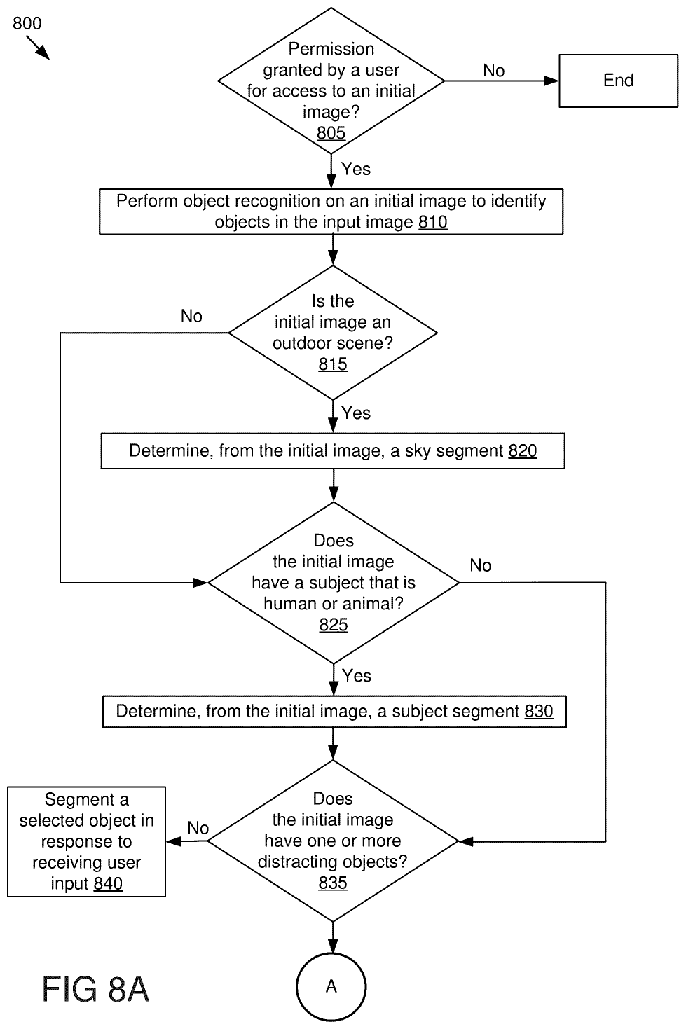

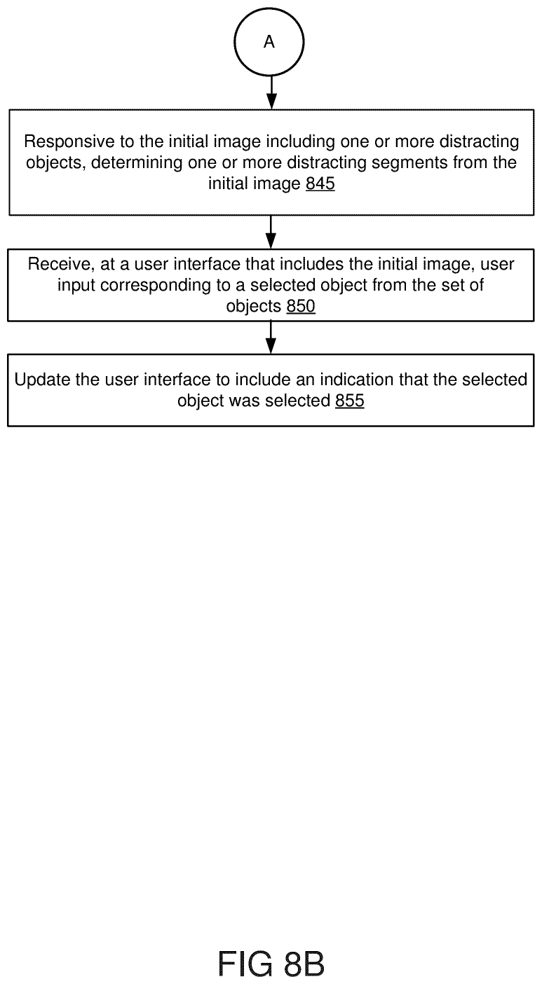

FIGS. 8A-8B illustrate an example flowchart of a method 800 to segment an initial image, according to some embodiments described herein. The method 800 may be performed by the computing device 200 in FIG. 2. In some embodiments, the method 800 is performed by the user device 115, the media server 101, or in part on the user device 115 and in part on the media server 101.

The method 800 of FIG. 8 may begin at block 802. At block 802, it is determined whether a user grants permission for access to an initial image. If the user does not grant permission, the method 800 ends. If the user does grant permission, block 802 may be followed by block 804.

At block 810, object recognition is performed on an initial image to identify objects in the input image. In some embodiments, performing object recognition to identify objects in the initial image includes determining object bounding boxes for each of the objects and the method further includes determining that the user input corresponds to the selected object based on a proximity of the user input to a closest object bounding box. Block 810 is followed by block 815.

At block 815, it is determined whether the initial image is an indoor scene. If the initial image is an indoor scene, block 815 may be followed by block 820. If the initial image is not an indoor scene, block 815 may be followed by block 825.

At block 820, a sky segment is determined from the initial image. Block 820 may be followed by block 825.

At block 825, it is determined whether the initial image has a subject that is human or animal. If the initial image has a subject that is human or animal, block 825 may be followed by block 830. In some embodiments, the method further includes responsive to the initial image including the subject, generating a background segment, wherein the subject segment is associated with a foreground region, the background segment is associated with a background region, and pixels in the initial image are associated with the foreground region or the background region and determining that the user input corresponds to the foreground region based on the user input making contact with pixels that are associated with the foreground region. If the initial image does not have a subject that is human or animal, block 825 may be followed by block 835.

At block 830, a subject segment is determined from the initial image. Block 830 may be followed by block 835.

At block 835, it is determined whether the initial image has one or more distracting objects. If the image does not have one or more distracting objects, block 835 may be followed by block 840.

At block 840, a selected object is segmented in response to receiving user input.

If the initial image has one or more distracting objects, block 835 may be followed by block 845 in FIG. 8B.

At block 845, responsive to the initial image including one or more distracting objects, one or more distracting segments are determined from the initial image. In some embodiments, a convolutional neural network (CNN) performs segmentation and the method 800 further includes providing the initial image and a heatmap of keypoints as input to the CNN and outputting, with the convolutional neural network, segmentation masks that correspond to the sky segment, the subject segment, and the one or more distracting segments. Block 845 may be followed by block 850.

At block 850, a user interface that includes the initial image receives user input corresponding to a selected object from the set of objects. The user input may include multiple taps of the selected object. In this instance, the method 800 may further include determining a number of taps from the user input and determining the selected object based on the number of taps, where a first tap is associated with a different region than a second tap.

In some embodiments, the user input includes selection of a sky and the method further includes receiving a request from a user to change a lighting in the initial image; providing, as input to a diffusion model, an initial image and a request to change a lighting in the initial image; and outputting, with the diffusion model, an output image that satisfies the request.

In some embodiments, the user input includes selection of one or more background objects for removal and the method further includes removing the one or more distracting objects from the initial image based on object recognition and generating a modified image that includes inpainting of pixels associated with the one or more distracting segments.

In some embodiments, the selected object is an incomplete object and an omitted portion of the incomplete object is cut off by a boundary of the initial image or obscured by another object, the method further includes generating a segmentation mask that includes the incomplete object; removing the incomplete object from the initial image; generating an inpainted image that replaces incomplete object pixels corresponding to the incomplete object with background pixels that match a background in the initial image; providing, as input to a diffusion model, the segmentation mask, the incomplete object, and the inpainted image; outputting, with the diffusion model, a complete object; and generating a modified image by blending one or more versions of the complete object with one or more versions of the inpainted image using the preserving mask. Block 845 may be followed by block 855.

At block 855, the user interface is updated to include an indication that the selected object was selected.

In some embodiments, the method further includes receiving a textual request to change the selected object in the initial image; determining, from the initial image, a face segment for a face of the subject based on the subject segment; generating a preserving mask that corresponds to the face segment; providing the textual request, the initial image, and the preserving mask as input to a diffusion model; and outputting, with the diffusion model, an output image that satisfies the textual request.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

According to the above description, a media application performs object recognition on an initial image to identify a set of objects in the initial image. The media application determines whether the initial image is an outdoor scene. Responsive to the initial image being an outdoor scene, the media application determining a sky segment from the initial image. The media application determines whether the initial image includes a subject that is human or animal. Responsive to the initial image includes the subject that is human or animal, the media application determines a subject segment from the initial image. The media application receives at a user interface that includes the initial image, user input corresponding to selection of a selected object from the set of objects. The media application updates the user interface to include an indication that the selected object was selected.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
performing object recognition on an initial image to identify a set of objects in the initial image;
determining whether the initial image is an outdoor scene;
responsive to the initial image being an outdoor scene, determining a sky segment from the initial image;
determining whether the initial image includes a subject that is human or animal;
responsive to the initial image including the subject, determining a subject segment from the initial image;
determining whether the initial image includes one or more distracting objects;
responsive to the initial image including one or more distracting objects, determining one or more distracting segments from the initial image;
receiving, at a user interface that includes the initial image, user input corresponding to selection of a selected object from the set of objects; and
updating the user interface to include an indication that the selected object was selected.

2. The method of claim 1, wherein the user input includes multiple taps of the selected object and further comprising:
determining a number of taps from the user input; and
determining the selected object based on the number of taps, wherein a first tap is associated with a different region than a second tap.

3. The method of claim 1, further comprising:
responsive to the initial image including the subject, generating a background segment, wherein the subject segment is associated with a foreground region, the background segment is associated with a background region, and pixels in the initial image are associated with the foreground region or the background region; and
determining that the user input corresponds to the foreground region based on the user input making contact with pixels that are associated with the foreground region.

4. The method of claim 1, wherein performing object recognition to identify objects in the initial image includes determining object bounding boxes for each of the objects and the method further comprises:
determining that the user input corresponds to the selected object based on a proximity of the user input to a closest object bounding box.

5. The method of claim 1, wherein a convolutional neural network (CNN) performs segmentation and the method further comprises:
providing the initial image and a heatmap of keypoints as input to the CNN; and
outputting, with the convolutional neural network, segmentation masks that correspond to the sky segment, the subject segment, and the one or more distracting segments.

6. The method of claim 1, wherein the user input includes selection of a sky and the method further comprises:
receiving a request from a user to change a lighting in the initial image;
providing, as input to a diffusion model, an initial image and a request to change a lighting in the initial image; and
outputting, with the diffusion model, an output image that satisfies the request.

7. The method of claim 1, wherein the user input includes selection of one or more background objects for removal and the method further comprises:
removing the one or more distracting objects from the initial image based on object recognition; and
generating a modified image that includes inpainting of pixels associated with the one or more distracting objects.

8. The method of claim 1, wherein the selected object is an incomplete object and an omitted portion of the incomplete object is cut off by a boundary of the initial image or obscured by another object, the method further comprising:
generating a preserving mask that includes the incomplete object;
removing the incomplete object from the initial image;
generating an inpainted image that replaces incomplete object pixels corresponding to the incomplete object with background pixels that match a background in the initial image;
providing, as input to a diffusion model, the preserving mask, the incomplete object, and the inpainted image;
outputting, with the diffusion model, a complete object; and
generating a modified image by blending one or more versions of the complete object with one or more versions of the inpainted image using the preserving mask.

9. The method of claim 1, further comprising:
receiving a textual request to change the selected object in the initial image;
determining, from the initial image, a face segment for a face of the subject based on the subject segment;
generating a preserving mask that corresponds to the face segment;
providing the textual request, the initial image, and the preserving mask as input to a diffusion model; and
outputting, with the diffusion model, an output image that satisfies the textual request.

10. A non-transitory computer-readable medium with instructions stored thereon that, when executed by one or more processors, cause the one or more processors to perform operations comprising:
performing object recognition on an initial image to identify a set of objects in the initial image;
determining whether the initial image is an outdoor scene;
responsive to the initial image being an outdoor scene, determining a sky segment from the initial image;
determining whether the initial image includes a subject that is human or animal;
responsive to the initial image including the subject, determining a subject segment from the initial image;
determining whether the initial image includes one or more distracting objects;
responsive to the initial image including one or more distracting objects, determining one or more distracting segments from the initial image;
receiving, at a user interface that includes the initial image, user input corresponding to selection of a selected object from the set of objects; and
updating the user interface to include an indication that the selected object was selected.

11. The non-transitory computer-readable medium of claim 10, wherein the user input includes multiple taps of the selected object and the operations further include:
determining a number of taps from the user input; and
determining the selected object based on the number of taps, wherein a first tap is associated with a different region than a second tap.

12. The non-transitory computer-readable medium of claim 10, wherein the operations further include:
responsive to the initial image including the subject, generating a background segment, wherein the subject segment is associated with a foreground region, the background segment is associated with a background region, and pixels in the initial image are associated with the foreground region or the background region; and
determining that the user input corresponds to the foreground region based on the user input making contact with pixels that are associated with the foreground region.

13. The non-transitory computer-readable medium of claim 10, wherein performing object recognition to identify objects in the initial image includes determining object bounding boxes for each of the objects and the operations further include:
determining that the user input corresponds to the selected object based on a proximity of the user input to a closest object bounding box.

14. The non-transitory computer-readable medium of claim 10, wherein a convolutional neural network (CNN) performs segmentation and the operations further include:
providing the initial image and a heatmap of keypoints as input to the CNN; and
outputting, with the convolutional neural network, segmentation masks that correspond to the sky segment, the subject segment, and the one or more distracting segments.

15. The non-transitory computer-readable medium of claim 10, wherein the user input includes selection of a sky and the operations further include:
receiving a request from a user to change a lighting in the initial image;
providing, as input to a diffusion model, an initial image and a request to change a lighting in the initial image; and
outputting, with the diffusion model, an output image that satisfies the request.

16. A system comprising:
a processor; and
a memory coupled to the processor, with instructions stored thereon that, when executed by the processor, cause the processor to perform operations comprising:
performing object recognition on an initial image to identify a set of objects in the initial image;
determining whether the initial image is an outdoor scene;
responsive to the initial image being an outdoor scene, determining a sky segment from the initial image;
determining whether the initial image includes a subject that is human or animal;
responsive to the initial image including the subject, determining a subject segment from the initial image;
determining whether the initial image includes one or more distracting objects;
responsive to the initial image including one or more distracting objects, determining one or more distracting segments from the initial image;
receiving, at a user interface that includes the initial image, user input corresponding to selection of a selected object from the set of objects; and
updating the user interface to include an indication that the selected object was selected.

17. The system of claim 16, wherein the user input includes multiple taps of the selected object and the operations further include:
determining a number of taps from the user input; and
determining the selected object based on the number of taps, wherein a first tap is associated with a different region than a second tap.

18. The system of claim 16, wherein the operations further include:
responsive to the initial image including the subject, generating a background segment, wherein the subject segment is associated with a foreground region, the background segment is associated with a background region, and pixels in the initial image are associated with the foreground region or the background region; and
determining that the user input corresponds to the foreground region based on the user input making contact with pixels that are associated with the foreground region.

19. The system of claim 16, wherein performing object recognition to identify objects in the initial image includes determining object bounding boxes for each of the objects and the operations further include:
determining that the user input corresponds to the selected object based on a proximity of the user input to a closest object bounding box.

20. The system of claim 16, wherein a convolutional neural network (CNN) performs segmentation and the operations further include:
providing the initial image and a heatmap of keypoints as input to the CNN; and
outputting, with the convolutional neural network, segmentation masks that correspond to the sky segment, the subject segment, and the one or more distracting segments.
